(19) United States
(12) Patent Application Publication
(10) Pub. No.: US 2021/0300241 A1
(43) Pub. Date: Sep. 30, 2021

(54) SOUND EMISSION DEVICE FOR ELECTRIC VEHICLES

(71) Applicants: The Electric Factory S.A., Montevideo (UY); Ayax S.A., Montevideo (UY)

(72) Inventors: Juan Ciapessoni, Montevideo (UY); Gustavo Etchandy, Montevideo (UY); Federico Cibils, Montevideo (UY); Juan Diego Vispo, Montevideo (UY); Alejandro Curcio, Montevideo (UY); Santiago Tarallo, Montevideo (UY); Guzman Calzada, Montevideo (UY)

(21) Appl. No.: 17/174,675

(22) Filed: Feb. 12, 2021

Related U.S. Application Data
(60) Provisional application No. 62/975,932, filed on Feb. 13, 2020.

(51) Int. Cl. B60Q 5/00

(52) U.S. Cl. CPC B60Q 5/008; B60Q 5/001

(57) ABSTRACT

The sound emission device for electric vehicles makes it possible to give sound to the motion of these vehicles, so that no sound reference is lost for pedestrians while they are in motion and their characteristic sound is a beneficial frequency for the vegetable world.

### RELATED APPLICATIONS

This application claims benefit of priority of U.S. Provisional Application No. 62/975,932, filed Feb. 13, 2020. The above-identified related application is incorporated herein by reference.

### FIELD OF USE

The present invention is directed to electric vehicles; and more particularly to a sound emission device for electric vehicles.

### BACKGROUND OF THE INVENTION

The arrival of electric vehicles represents a breakthrough towards a more sustainable and cleaner world. In recent years we have experienced a true revolution in terms of the progress of electric motors in means of transport, which means a greater capacity for adoption by the public of this type of technology.

The problem that arises from the widespread use of these types of vehicles lies upon pedestrians given that, electric vehicles, do not emit sound during the ride. This can be seen as a problem, given that the sound emitted by combustion engines serve the pedestrian to locate where the vehicle on the street is located thus estimating the level of risk.

### SUMMARY OF THE INVENTION

The present invention makes it possible to give sound to the motion of electric vehicles, so that the sound reference for pedestrians is not lost while they are in motion. Additionally, and to give an additional characteristic to the sound emitted by these vehicles, so that it be perceptible by the human ear and has an additional function that is to be beneficial for the city environment.

Based on experiments carried out in different Universities of the world, it has been found that frequencies in the environment of 15-250 Hz are beneficial for the vegetable world at different levels, from its growth to internal mechanisms of the plants and trees themselves. Thus, an opportunity has been found that electric vehicles, apart of eliminating air pollution, become a positive factor at the environmental level, since their characteristic sound could be a beneficial frequency for the plant world.

### BRIEF DESCRIPTION OF THE DRAWINGS

For the purpose of illustration, there are shown in the drawings certain embodiments of the present invention. It should be understood that the invention is not limited to the precise arrangements, dimensions, and instruments shown. In the drawings:

FIG. 1 illustrates a sound diagram associated with one embodiment of the sound emission device of the present invention.

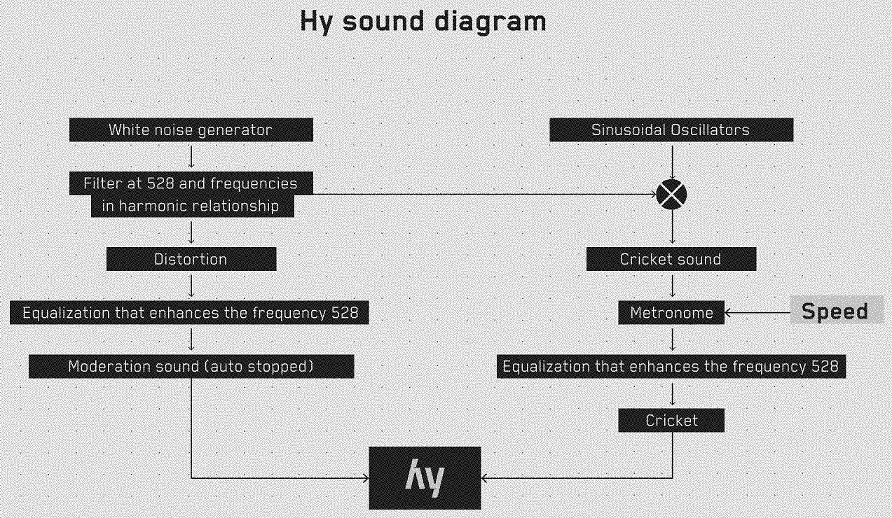

### DETAILED DESCRIPTION OF THE ILLUSTRATED EMBODIMENTS

The device takes four signals from the accelerator.

1. GND: Auto electrical circuit ground
2. VDC: Auto electrical circuit power (5V)
3. SW: Switch that goes from 0V to 5V when the pedal is operated
4. A: Output that varies between 0V and 3.06±0.02V*

Output A varies between 0V and 3.06V which is the response of a hall effect sensor that detects the distance or proximity of two magnets that move when the accelerator is pressed.

This output of the accelerator circuit is taken as input of the embedded system. It goes through a 10-bit digital analog converter with VCC reference voltage that provides a binary value between 0x000 and 0x3FF (hexadecimal notation). Then, this binary value is correlatively located at a minimum value and another maximum previously determined. These values are the maximum frequency and minimum frequency to reproduce that correspond to the range of frequencies that favor the development for the plants. From here the process can continue in two ways:
1. These frequencies are translated into a period of a digital PWM signal (pulse width modulation) that activates an active buzzer that is in the embedded system
2. This value determines which previously recorded sound will be played. It would be obtained from an integrated or similar SD memory.

This process is performed cyclically and at a high speed which allows the accelerator to be detected “in real time” since the speed with which the accelerator is checked again is less than the speed of the human action in pressing it.

The implementation of sound in the car will be through speakers strategically located in the car infrastructure.

What is claimed is:

1. A sound emission device for electric vehicles, wherein the device is configured to:
take the following four signals from an accelerator of the electric vehicle:
GND: Ground of the electrical circuit of the car;
VDC: Power circuit of the car (5V);
SW: Switch that goes from 0V to 5V when the pedal is operated; and
A: Output that varies between 0V and 3.06±0.02V*; and
process the four signals, resulting in an output, where the output determines a sound emitted in for from the electric vehicle.

2. The device of claim 1, characterized in that the output A varies between 0V and 3.06V which is the response of a hall effect sensor that detects the distance or proximity of two magnets that move when the throttle.

3. The device of claim 2, characterized in that the output passes through a 10-bit digital analog converter with VCC reference voltage that provides a binary value between 0x000 and 0x3FF (hexadecimal notation).

4. The device of claim 1, characterized in that the frequency range favors development for plants.
